(19) United States
(12) Patent Application Publication
(10) Pub. No.: US 2014/0237873 A1
(43) Pub. Date: Aug. 28, 2014

(54) Multi-Label Form for Prescription Delivery Process

(71) Applicant: Enrique Garay-Marrero, Carolina, PR (US)

(72) Inventor: Enrique Garay-Marrero, Carolina, PR (US)

(21) Appl. No.: 13/775,160

(22) Filed: Feb. 23, 2013

(51) Int. Cl. G09F 3/02

(52) U.S. Cl. CPC G09F 3/02
USPC 40/674

(57) ABSTRACT

A multi-label form, useful for printing data related to the medication delivering process is described. The form contains four main different label sections and most of the labels contain discreet and color defined subsections wherein the pertinent data is entered, organized and printed via a computer system. In particular label sections barcodes for electronic data readers in order to access information electronically saved are printed. Similarly, particular label sections also include particular locations for printing handwriting or electronically signature of the person to whom the medication has been delivered. Most of the label sections are correlated by the prescription number included in a particular subsections of the labels. After the printing, each particular label section is distributed to the medicament container, the patient, the pharmacy records and the health insurance records via the Pharmacy Benefit Management (PMB). The multi label form is preferably used with thermal printing process.

### TECHNICAL FIELD OF THE INVENTION

This invention relates to a multi-label form useful in printing data related to medication delivering process. More specifically, the instant invention is directed to a form used in computerized systems that comprises multiple label sections, wherein pertinent information related to the medication delivering process is printed in an organized and correlative manner in order to record such information to the patient, the pharmacy delivering the medication and health insurance corporation, according to local and federal legislation and retaining prima facie evidence of the person to whom the medication has been delivered for the pharmacy and health insurance records.

### BACKGROUND OF THE INVENTION

Prescribed drugs abuse is a growing problem in the United States of America and other countries. In USA, the National Institute of Drug Abuse, the Drug Enforcement Agency, the Food and Drugs Administration and other drug related agencies had estimated that 20 percent of people in the United States have used prescription drugs for nonmedical reasons and that said abuse is growing. Abusing some prescription drugs can lead to addiction, loss of productivity, loss of health and eventually death, thus impacting the general community in multiple manners. Similarly, the National Drug Control Policy has indicated the prescription drug abuse is the nation's fastest-growing drug problem and that the prescribed drug abuse is the second-most abused category of drugs after marijuana, and the second leading cause of accidental death in the U.S. after car accidents.

Recently, the federal government has directed efforts and coordinates strategies to reduce or eliminate the prescription drug problem. Representatives from the Food and Drug Administration (FDA), Drug Enforcement Administration (DEA), Center for Disease Control and Prevention (CDC) and Health and Human Services (HHS) announced the Obama administration's new National Prescription Drug Abuse Plan aimed at saving lives and stemming the abuse. Said quite expensive plan includes better tracking and monitoring of painkillers, better and more organized drug disposal plans, education programs to make patients and doctors aware of the risk, and better enforcement aimed at eliminating pill mills and doctor shopping.

On the other hand and besides the prescription drug abuse, mistakes in the medication delivery process represent a high risk of increasing the health problems of a patient and in some circumstances may be fatal.

Therefore, there is a need of properly collecting, organizing and controlling the information related to the medication delivery process at the same time that there is a full compliance with pertinent federal and local regulations directed to protect the patient right-to-know essential information of the prescribed medicament together with transmitting said information to health insurance companies and maintaining said information in the pharmacy records. There is also a need of reducing the time required to comply with said collection of information at the medication delivery process and to properly record direct evidence of the person to whom the medication is finally delivered and to further reduce the cost involve in said process. While the prior art discloses multiple forms or labels to collect information related to the medication delivery process, none of said forms fully comply with the herein described needs.

### OBJECTS AND SUMMARY OF THE INVENTION

It is an object of the invention to provide a multi-label form, useful for printing data pertinent to the process of delivering a medication in a pharmacy in different labels via a computerized system in order to satisfy the Clients right to know information regarding the medication and prescription and recording the electronic signature of the person to whom the medication is delivered, in order to drastically reduce any potential fraudulent or abuse acquisition of prescribed medication.

Another object of the invention is to provide a multi-label form having different label sections and subsections in order to organize a concrete and define space, wherein the data pertinent to the delivering process of a prescribed medication is legibly printed and wherein different label sections are correlated by the prescription number in order to fully comply with federal and local legislation.

Another object of the invention is to provide a multi label form wherein (a) a label section is used to properly label the medication container with the pharmacy information, the patient name, the medication characterization data such as name of the medicine, active amount, number or quantity of units, number of refills, national drug code and similar data and data of the doctor who prescribed such medication; (b) a label section directed to the patient's health insurance via the Pharmacy Benefit Management, also known in the art as PBM, in order to provide the details of the delivery, and maintain a clear record of the medications delivered covered under its control, (c) a label section with details of the medication delivery and the signature of the person to whom the medication has been delivered to be maintain in the pharmacy records as a prima facie evidence of the delivery and of the person receiving the medication and (d) at least another section label which includes the mentioned data as the previous label and further includes a barcode related to the number of the prescription, signature and the amount of money paid for the medication that is useful for the Client records. Still another object of the invention is to provide a multi label form of a reduced size, which provided printing surface for information regarding the medication delivery process and wherein said printing process is a thermal printing process using a suitable thermal printer in order to reduce the cost of said process by reducing the amount of paper and eliminating the need of expensive toner cartridges. In yet another objective of the invention is to provide a multi-label form that reduces the time for delivering a medication by providing all the required labels in a single compact multi-label form.

### BRIEF DESCRIPTION OF THE DRAWINGS

The foregoing and additional features and characteristics of the embodiments of the present invention will become more apparent from the following detailed description considered with reference to the accompanying drawings, which are used herein in a manner of example only, and wherein:

FIG. 1 Illustrates front view of an embodiment of the multi-label form according to the instant invention, showing the different label sections and subsections wherein information regarding the prescription delivery process is printed and organized.

FIG. 2 illustrates the back surface of the embodiment of the form illustrated in FIG. 1.

FIG. 3A, 3B. 3C and 3D illustrates the front surface of each one the label sections of the multi-label form according to the instant invention.

FIGS. 4A, 4B, 4C and 4D illustrates the back surface of each one of the label sections of the multi form according to the invention.

FIG. 5 illustrates an embodiment of the invention form wherein some general indicia has been printed.

FIG. 6 illustrates an embodiment of the multi-label form according to the invention, wherein the pertinent information has been already printed in each one of the label sections.

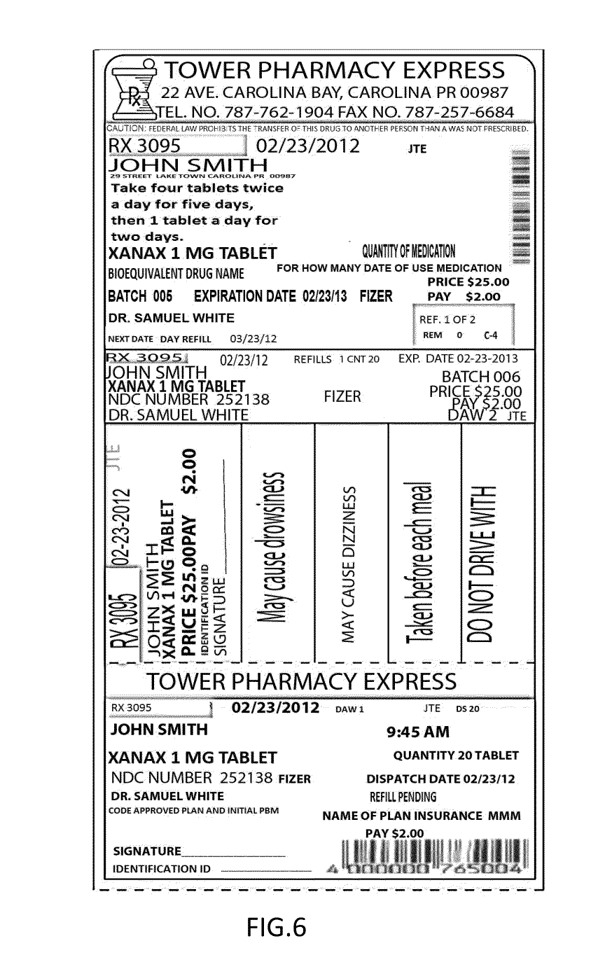

### DETAILED DESCRIPTION OF THE EMBODIMENTS

The following detailed description illustrates the invention by way of example and is not limited to the particular limitations presented herein as principles of the invention. This description is directed to enable one skilled in the art to make and use the invention by describing embodiments, adaptations, variations and alternatives of the invention. Potential variations of the limitations herein described are within the scope of the invention. Particularly, the size and shapes of the invention's elements illustrated in the discussion may be varied and still provide multi-label forms having different or additional elements, that are within the scope of the instant invention.

The instant invention is directed to a multi-label form 10, useful for imprinting data related to a medication delivery process. The herein disclosed multi-labels form 10 provides independent and separately removable labels, some of them having specific subsections wherein information related to the medication delivery process is collected and printed in an integrated and well organized manner in such a way that the possibilities of confusion or potential mistakes are minimized or even eliminated and in order to comply with federal and state regulations. Each subsection within a given label section has its own color in order to distinguish and clearly define the area of a given subsection from the others. Each label is directed to a particular entity related to the medication delivery process such as the patient, the pharmacy and the health insurance records, thus increasing the delivering data control. Similarly, the integration of information or data reduces the time for completing the medication delivering process while properly complying with providing related data that may be required by different government regulations in benefit to pharmacies, patients and the health insurance corporations. For instance, the herein disclose form provides labels directed to inform the patient important details regarding the particular medication being delivered; labels containing proof of delivery that are maintained as pharmacy records regarding all the delivered medicines and labels directed to comply with health insurance requirements.

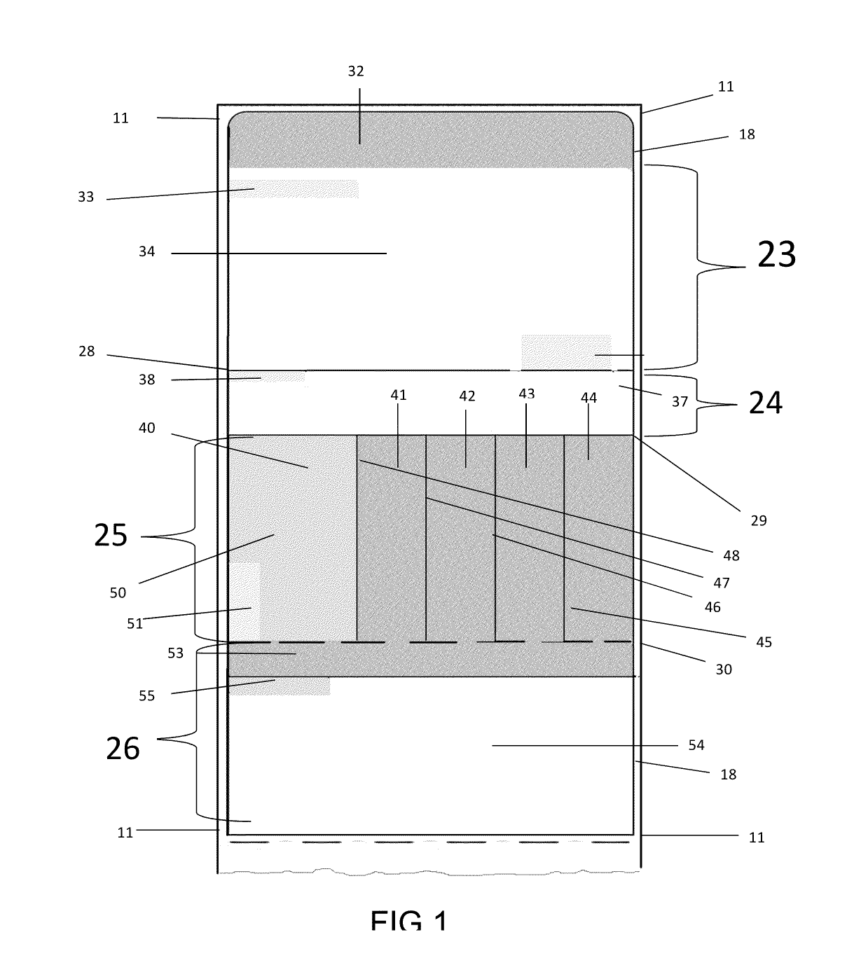

In reference to the drawings, FIG. 1 illustrates the front side of the multi-label form 10 according to the invention. Multi-label form 10 may have different sizes; nonetheless it is prefer a size of 2 to 3 inches wide and 5 to 6 inches long; even more preferred 2⅞ inches width by 5¾ inches length. It is intended to be used in computerized systems wherein by means of a suitable and already installed software, the data is entered, conveniently saved for the pharmacy records and further printed out and adhered to the particular place at the convenience of the client, the pharmacy and the health insurance policies, as explained below in more details.

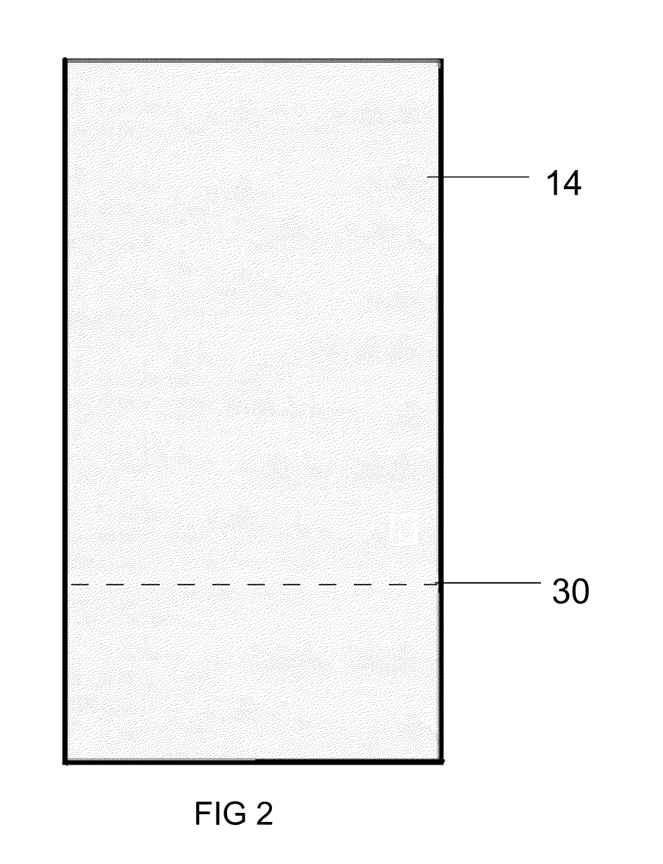

As illustrated in FIGS. 1 and 2, multi-label form 10 comprises a first layer 11 having a front surface 12 and a back surface 14 and a second layer 18 having a front surface 20 and a back surface 21. It is formed by joining the back surface 21 of second layer 18 to the front surface 12 of layer 11 by means of a suitable adhesive placed on back surface 21 a manner that the second layer 18 covers at least a section of the front surface of the first layer 11.

First layer 11 is may be preferably made of any suitable paper in the art that allows a smooth separation of the labels formed by second layer 18 from its surface without retaining the suitable adhesive used to join said first layer 11 to the second layer 18, while adding physical stability to the multi-label form 10. FIG. 2 illustrates the back surface 14 of first layer 11. As Illustrated in FIG. 1, the lateral borders 14 of the first layer 11 are not overlap by the second layer 18, thus facilitating the removal of the different labels. Regarding second layer 18, it may be made of a paper suitable for being printed upon. In one embodiment of the invention, said printing paper should be a paper suitable for ink printing. However in the most preferred embodiment of the invention, second layer 18 is a thermal printing paper suitable for thermal printing process.

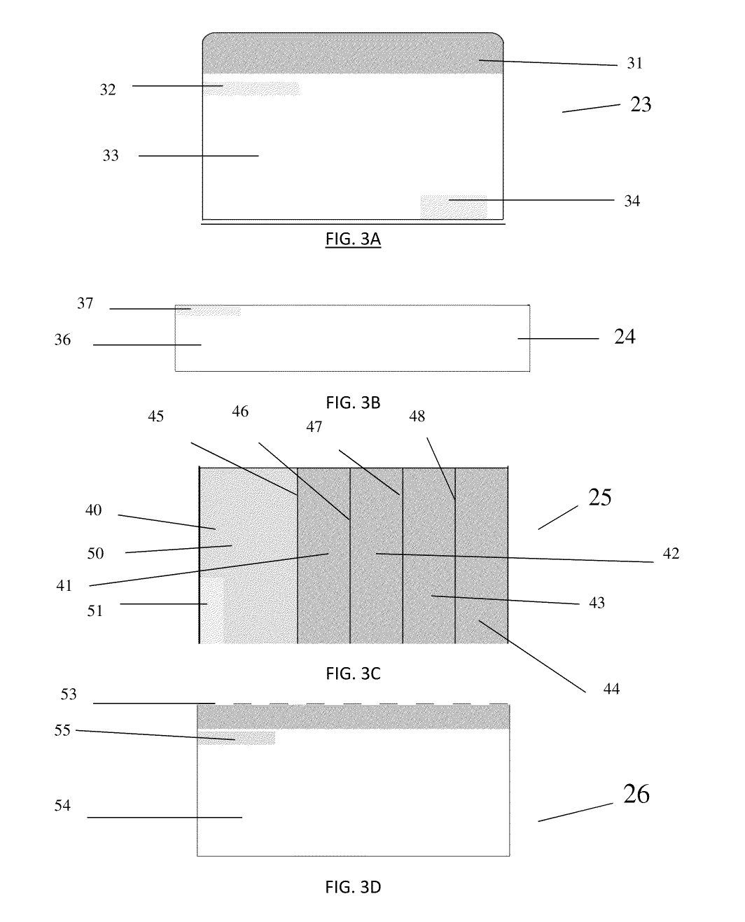

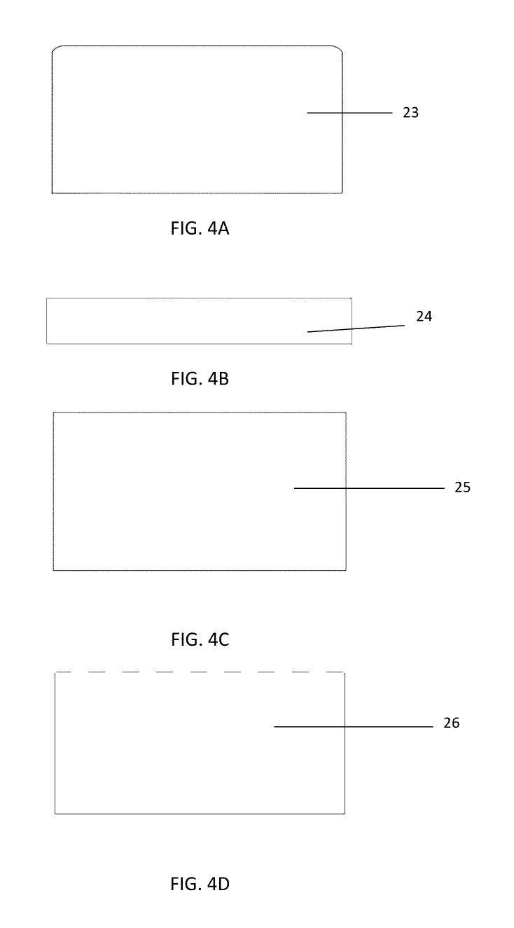

As illustrated in FIG. 1 and FIG. 3, second layer 18 is divided in particular and individual self-adhesive label sections 23, 24, 25 and 26 directed to provide the printed information to different entities related to the medication delivery process. FIGS. 3A, 3B, 3C and 3D illustrate the front surfaces of said sections respectively and separately from first layer 11. On the other hand, FIGS. 4A, 4B, 4C and 4D illustrate the back surface of said label sections in which layer 18 is divided.

The divisions of second layer 18 are achieved via the respective transversal cut lines 28, 29 and 30 as illustrated in FIG. 1. Such cuts lines may be of any suitable transversal cuts along the second layer 18 or along both layers 11 and 18, in this manner facilitating the removal of the label sections 23, 24, 25 and 26 in an independent or individual manner. For instance, said cuts may be weakening cut, knife cuts or died cut types or any suitable combination of said cuts crossing along second layer 18 only. Alternatively, said cuts may be crossing across both: first layer 11 and second layer 18. In a preferred embodiment of the invention, as illustrated in FIG. 1, cuts 28 and 29 are died cuts lines across second layer 18 only, while, as illustrated in FIGS. 1 and 2, cut 30 is a weakening cut line across first layer 11 and second layer 18.

Regarding label section 23, as illustrated in FIG. 3A, it comprises a single label section, wherein the phrase single section as used herein indicates that the whole body of said label section constitutes a single label or entire label by itself. Label section 23 is intended to be posted at or adhered to the external surface of the medicament container. Particularly and as illustrated in FIG. 3A, single label section 23 comprises four different individual subsections: top subsection 31; main subsection 33, which is located below said top subsection 31; a left side subsection 32, preferably located at the left section of the main section 33 and right side subsection 34, preferably located at the right section of the main subsection 33. The area of each particular subsection is preferably defined by using different colors for each area, thus allowing concrete locations on said label 23 wherein specific data regarding the medication delivery process is organized, printed and easy to identify by the patient. For instance, top subsection 31 is intended for printing the identification and contact information of the pharmacy in charge of delivering the medicament. More particularly, in said section it may be included the name of the pharmacy, its logo, address and fax and phone numbers. Main subsection 33 provides a precise location to include pertinent data regarding the medication delivery process according to the pharmacy or legal policies. For instance, it may include the date of the delivery of the medication, name of the patient to whom the medication has been prescribed, data related to the medicament such as national drug code, proper name of the medicament, amount of biologically active ingredient, quantity of units, name of the doctor in medicine who prescribes the medicament and any other similar and/or pertinent information. Additionally, a barcode is included at the right corner of subsection 33 as an electronic record of the transaction using the prescription number. Similarly, subsection 32 provides a concrete and particular location on label 23 wherein the prescription number that order the medication is printed out while on subsection 34 a particular place for printing the number of refills for the medication. In one of the preferred embodiments of the invention, label section 23 has a size of 2.5 inches long by 3 inches width. In an even preferred embodiment, label section 23 has dimensions of 2 inches long by 2⅞ inches wide.

Similar to section label 23, label section 24 is a single label which comprises main section 36 and discrete right subsection 37. The area of each subsection is defined by using a particular color for each area. Main section 36 is used to print out the name of the patient, the national drug code or similar identifier of the medicament, date that the prescription is delivered, the medicament cost and the amount of money that has been paid to the pharmacy for the medicament. Additional similar or pertinent information such as the name of the doctor who prescribed the medicament may also be included. On the other hand, subsection 37 is intended to print out the number of the prescription. Single label 24 is intended to be sent to the health insurance of the patient via the Pharmacy Benefit Management also known in the art as PBM, for instance, in order to fully comply with local and federal regulations and to properly inform the details of the transaction to the health insurance provider. In this manner health insurance may keep a clear track of each delivered medication, the identification of medication being delivered and commercial details of each transaction. In one of the preferred embodiments of the invention, label section 24 has a size of 0.25 to 0.75 inches long per 2 to 3 inches width. In an even preferred embodiment, label section 24 has dimensions of 0.5 inch long by 2⅞ inches wide.

Single label 23 is separated and individualized from single unit 24 preferably via died cut 28, that cross along layer 18, thus separating each said label sections and facilitating the removal or release of said single label sections as independent labels.

Form 10 also includes multi-label section 25 which according to the invention requires at least five independently and separate label units 40, 41, 42, 43 and 44. Each one of said label units are longitudinally separated from one from another by longitudinal die cuts lines, for instance died cut 45 separates label unit 40 from label unit 41, died cut line 46 separates label unit 41 from label unit 42; died cut line 47 separates label unit 42 from label unit 43 while died cut line 48 separates label unit 43 from label unit 44. Label units 41, 42, 43 and 44 have preferably and substantially the same dimensions and are indented to provide a particular discrete label wherein specific and potential important warnings or indications regarding the medication being prescribed and delivered are printed out and adhered to the medicament container. In one of the preferred embodiments of the invention, each label units 41, 42, 43 and 44 has a size of 1 to 3 inches long per 0.2 to 1.5 inches wide. In an even preferred embodiment, each label units 41, 42, 43 and 44 has dimensions of 1 6/8 inches long by 0.5 inch wide.

On the other hand, label unit 40 comprises main section 50 and a left subsection 51. As previously explained for label sections 23 and 24, each area of said subsections 50 and 51 is defined by means of using a particular color for each subsection. On main section 50 is printed at least the prescription delivery date, name of the patient, identification of the medicament being delivered, cost being paid for the medicament and the electronic or handwriting signature of the person receiving the medicament directly from the pharmacist and the manner used by the pharmacist to properly identify the person in charge of receiving the medication is included electronically. In subsection 51 it is printed the number of the prescription in a manner that all the information printed in all main labels of the multi-label form 10 are properly inter correlated. This label is conveniently kept by the records of the pharmacy delivering the medicament in order to maintain clear, concise and precise evidence of the medicament delivered, the prescription information; the person to whom the medicament has been prescribed and the proper identification of the person to whom the medication has been delivered as corroborated by the pharmacist in charge of the delivering. In one of the preferred embodiments of the invention, label unit 50 has a size of 1 to 2 inches long by 0.2 to 1.5 inches wide. In an even preferred embodiment, said label 50 has dimensions of 1 6/8 inches long and 1 inch wide.

Single label 24 is separated and individualized from single unit 25 via died cut 29, that cross along layer 18, thus separating each said sections and facilitating the removal or release of single label sections 24 and 25 as independent single label units.

Similarly, single label section 26, comprises top section 53, main section 54, which is located below said top section 53 and left side subsection 55, which is preferably located at the top left section of main section 54. In the top section 53 as in subsection 31 of label section 23, the identification of the pharmacy, such as name, logo, address and fax and phone numbers may be printed. Similarly, on subsection 55, the number of the prescription is printed in order to correlates label section 26 with label unit 50 and label sections 23 and 24, since all said sections contained the printed number of the prescription in a clearly defined particular area. On the other hand, in main section 54, is printed general and particular information, that should include at least: the name of the patient to whom the medicament has been prescribed; date of medicament delivery; name, biological prescribed dose and national drug code of the medication; name and license number of the doctor prescribing the medicament; amount of medication refills and amount to be paid by the patent for the medication. Section 54 must also include a place to print out the electronic or handwriting signature of the person picking up the medicament and a barcode identifying the transaction details, which allows to automatically reading product information during checkout. Label section 26 is used as a receipt to the person to whom the medication is delivered. At the moment the medicament is delivered, said barcode is scanned in order to indicate the register the amount of money to be paid. Multi-label section 25 is separated and individualized transversally from single unit 26, via weakening line 30, that cross along layers 11 and 18, thus separating each individual sections 25 and 26 and facilitating the removal or release of single label sections 25 and 26 as independent single label sections. Particularly, section 26 is separated from the form 10, while having the corresponding section of both the first layer 12 and second layer 18 and further staple in the bag containing the delivered medication. In this manner, the patient may conveniently kept said label section 26 for his or her medical records. In one of the preferred embodiments of the invention, label section 26 has a size of 2.5 to 3 inches length per 1.5 to 2 inches width. In an even preferred embodiment, label section 26, has dimensions of 1 4/8 inches length per 2⅞ inches width.

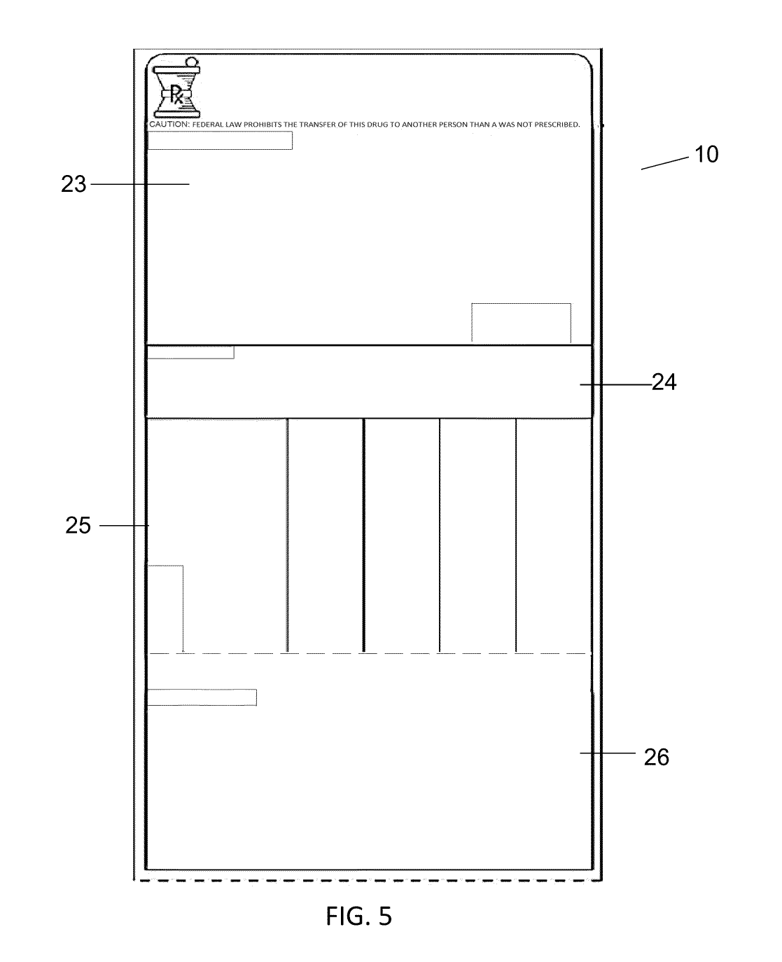

Multi-label form 10 may be imprinted with some general indicia as the one illustrated in FIG. 5, wherein general data is already included previous to being fed to a suitable printer. Alternatively, multi labels form 10 may be used to print the described data without any indicia or totally blank, as illustrated in FIG. 1.

In operational terms, multi-labels form 10 is fed though a printer connected to computerized system in order to imprint on the particular labels the particular data regarding the medication delivery process. As indicated above, the most preferred embodiment of the invention, wherein the second layer 18 is made of thermal sensitive paper requires a thermal printer.

Once the information has been fed into the computer system, the multi label form is print out and label sections 23, 24 and 25 are removed by peeling them off separately from the first layer 11. Single label 23 and required label units 41, 42, 43 and 44 label are adhesively adhered or stuck to the medication container. Label section 24 is kept by the pharmacy and later provided to the Pharmacy Benefit Management (PBM) from whom it is then provided to the health insurance provider.

Label unit 50, after being signed by the person picking up the medication is kept in the pharmacy records. On the other hand, label section 26 is handed to the client or attached to the medicament bag maintaining its section of the first layer 11, in order to supply the patient with relevant and pertinent information regarding the prescription. It should be understood that additional pertinent information may be printed in each label section of multi-label form 10 depending on local or federal regulations or at the convenience of the corresponding policies of a given pharmacy.

While the invention has been described in conjunction with some embodiments, it is to be understood that many alternatives, modifications, and variations will be apparent to those skilled in the art in light of the forgoing description. Accordingly, the invention is intended to embrace all such alternatives, modifications and variations falling within the spirit and scope of the appended claims.

1. A multi-label form useful imprinting information via a printer, said multi-label form comprising:
a first layer comprising a front surface and a back surface;
a second layer, said second layer comprising:
a front surface suitable for being printed upon;
a back surface, said back surface being removably adhered on the front surface of the first layer in a manner that the second layer covers at least a section of the front surface of the first layer;
a first single label section, said first label section comprising:
a top section;
a main section located below said top section;
a left side subsection located at the left section of the main section and;
a right side subsection located at the right section of the main subsection;
a second single label section comprising:
a main section and
a right subsection;
wherein a die cut crossing across and separating the first single label section from the second single label section, thus facilitating the removal or release the first and second single label sections from the first layer in an independent manner;
a third multi-label section, said third multi-label section comprising:
at least five independently and separate label units, which are separated by die cuts lines, wherein at least four of said five label units have substantially the same dimensions and;
at least one of label units comprises a main section and a left subsection and;
wherein a die cut crossing across and separating the second single label section from the third multi-label section facilitating the removal or release the second and third single label sections from the first layer in an independent manner;
a four single label section, said four label section comprising:
a top section;
a main section located below said top section;
a left side subsection and;
wherein a weakening line cutting across the first and the second layers and separating the fourth single label section from the rest of the multi label sections as an independent section.

2. The multi-label form as recited in claim 1, having a size of 2 to 3 inches wide and 5 to 6 inches long.

3. The multi-label form as recited in claim 2, having a size of 2⅞ inches width by 5¾ inches length.

4. The multi-label form as recited in claim 1, wherein the color of the top section, the main section and the left and right side subsections at the first single label section are different.

5. The multi-label form as recited in claim 1, wherein each subsection and the section that is next to each subsection have a different color.

6. The multi-label form as recited in claim 1, wherein the four label units of the third label section having substantially the same dimensions have the same color.

7. The multi-label form as recited in claim 1, wherein each of the four label units of the third label section having substantially the same dimensions has a different color.

8. The multi-label form as recited in claim 1, wherein the second layer is made of a suitable thermal printing paper.

9. A multi-label form, useful imprinting information via a printer, said multi-label form comprising:
a first layer comprising a front surface and a back surface;
a second layer made of suitable thermal printing paper, said second layer comprising:
a front surface suitable for being printed upon;
a back surface, said back surface being removably adhered on the front surface of the first layer in a manner that the second layer covers at least a section of the front surface of the first layer;
a first single label section, said first label section comprising:
a top section;
a main section located below said top section;
a left side subsection located at the left section of the main section and;
a right side subsection located at the right section of the main subsection;
a second single label section comprising:
a main section and
a right subsection;
a die cut crossing across and separating the first single label section from the second single label section, thus facilitating the removal or release the first and second single label sections from the first layer in an independent manner;
a third multi-label section, said third multi-label section comprising:
at least five independently and separate label units, which are separated by die cuts lines, wherein at least four of said five label units have substantially the same dimensions and;
at least one of label units comprises a main section and a left subsection and;
a die cut crossing across and separating the second single label section from the third multi-label section facilitating the removal or release the second and third single label sections from the first layer in an independent manner;
a four single label section, said four label section comprising:
a top section;
a main section located below said top section;
a left side subsection and;
a weakening line cutting across the first and the second layers and separating the fourth single label section from the rest of the multi label sections as an independent section and wherein the whole multi-label form has assize of 2⅞ inches width by 5¾ inches length.
